(19) United States
(12) Patent Application Publication
(10) Pub. No.: US 2022/0314764 A1
(43) Pub. Date: Oct. 6, 2022

(54) Automotive Windshield and Hood Cover Device

(71) Applicant: Ground Formation Xtreme Landscape Construction Inc., Ottawa (CA)

(72) Inventor: Clifford Prudhomme, Ottawa (CA)

(73) Assignee: Ground Formation Xtreme Landscape Construction Inc., Ottawa (CA)

(21) Appl. No.: 17/523,313

(22) Filed: Nov. 10, 2021

Related U.S. Application Data
(60) Provisional application No. 63/169,478, filed on Apr. 1, 2021.

(51) Int. Cl. B60J 11/08

(52) U.S. Cl. CPC B60J 11/08

(57) ABSTRACT

The present invention relates to a windshield and hood protective cover for protecting the windshield, cowl grill or vent, wiper arms and blades and a portion of the vehicle hood from accumulation of snow and ice. The windshield and hood protective cover comprises a thin flexible sheet with an attached flap. The flexible sheet can be generally rectangular in shape, and can be designed to cover the windshield area of the vehicle, while the flap can be designed to cover a portion of the hood of the vehicle. The flexible sheet can feature a plurality of protrusions to enable the shedding of ice and snow from the windshield, and prevent any damage to the vehicle. The protective cover can be manufactured in a generic size to fit a majority of vehicles, or can be custom-made to fit specific vehicles.

### CROSS-REFERENCE TO RELATED APPLICATION

The present application claims priority to, and the benefit of, U.S. Provisional Application No. 63/169,478, which was filed on Apr. 1, 2021 and is incorporated herein by reference in its entirety.

### FIELD OF THE INVENTION

The present invention relates generally to the field of automotive covers. More specifically, the present invention relates to a windshield and hood protective cover for protecting the windshield, cowl vent, wipers, wiper cowl and a portion of the hood from accumulation of snow and ice. The cover includes one solid piece of thin flexible rubber with an attached flap. The thin flexible rubber includes a pair of handles for placing the cover on the vehicle. The cover can be manufactured in a generic one size fits all, or can be custom made to fit specific vehicles. The cover slides into the cowl area and the flap protects a rear section of the hood. Accordingly, the present disclosure makes specific reference thereto. Nonetheless, it is to be appreciated that aspects of the present invention are also equally applicable to other like applications, devices and methods of manufacture.

### BACKGROUND

By way of background, vehicles are generally parked outside, and in a winter climate where snow, ice and freezing rain are commonplace, the vehicles, especially the windshield, cowl area and wipers can become laden with snow and ice. The ice and snow build-up on the windshield wipers, arms and blades can cause damage to the rubber of the wipers and wiper nozzles, requiring them to be replaced. For clearing ice from the windshield, generally an ice scraper is typically used. Clearing heavy ice using the scraper is a laborious and time-consuming task. Further, the scraper can cause scratches on the windshield and cowl grill that reduce the quality of the windshield and surrounding areas. Accumulated snow and ice often causes the wiper fluid spray nozzles to become clogged or frozen, which makes it virtually impossible to use the fluid for clearing the windshield.

In cases where the snow is very heavy, or as a result of snowstorms or hailstorms, the weight of the falling snow can also break the windshield or damage the cowl grill area. Drivers are often unable to immediately replace a broken window, leaving a vehicle interior vulnerable to weather damage. Interior damage resulting from a broken window left unattended can cost several times more than window repair alone.

It is extremely difficult to remove snow from the cowl area between the hood and the windshield. Additionally, snow in the cowl area can melt, and the melted ice can reach the engine which may cause extreme problems for the drivers. Currently available windshield covers do not cover the windshield and other components of the vehicle, especially if the cowl area is left unprotected. Covers heretofore known require assembly and disassembly for use.

Therefore, there exists a long felt need in the art for an automotive windshield protective cover that protects the windshield, cowl area and hood from snow and ice. There is also a long felt need in the art for an automotive windshield protective cover that can be easily installed. Additionally, there is a long felt need in the art for an automotive windshield protective cover that does not require any assembly or disassembly. Moreover, there is a long felt need in the art for an automotive windshield protective cover that eliminates the use of ice scrapers and protects wiper or windshield fluid spray nozzles. Furthermore, there is a long felt need in the art for an automotive windshield protective cover that is easy to carry and can be stored in the vehicle. Finally, there is a long felt need in the art for an automotive windshield protective cover that effectively prevents damage to a vehicle's windshield, wiper arms and blades, and cowl area caused by ice and snow build-up and removal of same.

The subject matter disclosed and claimed herein, in one embodiment thereof, comprises an automobile windshield, wiper blades, cowl grill and hood cover. The automobile windshield and hood cover prevents several components of a vehicle from inclement weather, and the damage associated with the buildup and removal of ice and snow. The cover features a flexible windshield sheet for protecting the windshield, and a flap permanently attached to the top surface of the windshield sheet for protecting the hood of the vehicle. A portion of the windshield sheet lies underneath the flap, wherein the overlapped portion of the sheet protects a cowl area of the vehicle and the flap protects the hood of the vehicle.

In this manner, the automobile windshield and hood cover of the present invention accomplishes all of the forgoing objectives and provides a relatively safe, convenient and cost-effective windshield, cowl area, wipers and hood protective device that can be easily deployed, installed and removed with convenience. The cover provides a quick way to clear ice and snow from a windshield so that the vehicle can be driven immediately after experiencing an episode of winter weather. The cover also prevents scratches on the windshield caused by an ice scraper during snow and ice removal.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises an automobile windshield and hood cover. The automobile windshield and hood cover is designed for protecting several components of a vehicle from inclement weather and the damage associated with the buildup and removal of ice and snow. The cover further comprises a flexible windshield sheet extending across the length and width of the windshield, a flap permanently attached to the top surface of the windshield sheet wherein the attachment is near a bottom edge of the windshield sheet and extending laterally across the width of the windshield sheet, and a portion of the windshield sheet lies underneath of the flap, wherein the portion lies from the lateral attachment to the bottom edge of the windshield sheet. The windshield sheet protects the windshield of the vehicle. The underneath portion, or overlapping portion, protects a cowl area of the vehicle, and the flap protects the hood of the vehicle.

In yet another embodiment, the bottom edge of the windshield sheet fits into the cowl area and the flap covers a section of hood, thereby enabling the flap to overlap the portion of the windshield sheet. In yet another embodiment of the present invention, the flap covers the hood of the vehicle up to a section approximately 18 inches from the cowl area.

In yet another embodiment, the top surface of the windshield sheet includes indicia in the form of a logo, trademark, copyright, tag line or any other design. The top surface can also have projections along the surface for shedding snow and ice, and prohibiting accumulation of same, and also for protection from impact.

In yet another embodiment of the present invention, a windshield weather protector device is disclosed. The device comprises one solid piece of thin flexible rubber sheet with an attached flap. The thin flexible rubber sheet can be a generally rectangular sheet with a top edge to be placed near the top edge of the windshield, a bottom edge to fit over the cowl area and a pair of side edges for placement near the side edges of the windshield. A pair of handles disposed on the pair of side edges enables a user to place the device on the windshield. The flap can attach to the thin flexible rubber sheet at a longitudinal and overlapping distance of generally from about 4 inches to about 12 inches, thereby enabling the flap to cover a portion of the hood of generally about 4 to 18 inches from the cowl area.

In yet another embodiment of the present invention, a windshield and hood cover for a vehicle is disclosed. The cover includes a planar windshield protection sheet that extends from a top of the windshield to the cowl vent area of the vehicle, wherein a portion of the sheet fits over or into the cowl vent area. A flap cover overlaps a portion of the sheet that fits over or into the cowl vent area for covering a section of hood of the vehicle wherein the flap extends generally from the base of the windshield to at least the windshield spray nozzles disposed on the hood.

In yet another embodiment of the present invention, the cover can be made from a flexible, sturdy, durable and non-stick material. In yet another embodiment, the cover protects the windshield, the cowl area and a portion of the hood of a vehicle from snow and ice, and thereby prevents scratches on the windshield and damage to the wipers that can be caused by an ice scraper during snow and ice removal.

In yet another embodiment of the present invention, the windshield protecting sheet can have a thickness of between 0.2 inches and 2.0 inches, and the overlapping flap can include a thickness of between 0.2 inches and 2 inches. The windshield protecting cover includes dimensions of generally about 50 inches to about 80 inches from side to side, and generally about 30 inches to about 60 inches from the top edge to the bottom edge.

In yet another embodiment of the present invention, a method of using a vehicle windshield and hood cover is described. The method includes the steps of initially overlaying the windshield sheet on the windshield, such that the sheet covers the windshield from side to side and from top edge of the windshield to the cowl area, then fitting the bottom edge of the windshield sheet into or over the cowl area for properly covering the cowl area, and finally placing the flap, which is attached to the windshield protection sheet overlapping the cowl area, over a portion of the hood.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of an automotive windshield and hood protecting cover of the present invention in accordance with the disclosed architecture;

FIG. 2 illustrates a planar view of another potential embodiment of the windshield protecting cover of the present invention in accordance with the disclosed architecture;

FIG. 3 illustrates a perspective view of one potential embodiment of the windshield and hood protection cover of the present invention placed on a vehicle for covering a windshield and a hood in accordance with the disclosed architecture;

FIG. 4 illustrates a close-up perspective view of how a portion of one potential embodiment of the sheet portion of the present invention is placed underneath the flap for covering a cowl area in accordance with the disclosed architecture;

FIG. 5 illustrates a perspective view showing one potential embodiment of the windshield protecting cover covering the windshield and hood of the vehicle in accordance with the disclosed architecture; and

FIG. 6 illustrates a flow diagram showing exemplary steps performed by a user for using one potential embodiment of the windshield and hood protection cover of the present invention on a vehicle in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long felt need in the art for an automotive windshield protective cover that protects the windshield, cowl area and hood from snow and ice. There is also a long felt need in the art for an automotive windshield protective cover that can be easily installed and retained in place. Additionally, there is a long felt need in the art for an automotive windshield protective cover that does not require any assembly or disassembly. Moreover, there is a long felt need in the art for an automotive windshield protective cover that eliminates the use of ice scrapers and protects wiper fluid or windshield fluid spray nozzles. Furthermore, there is a long felt need in the art for an automotive windshield protective cover that is easy to carry and can be stored in the vehicle. Finally, there is a long felt need in the art for an automotive windshield protective cover that effectively prevents damage to a vehicle's windshield, wiper arms and blades, and cowl area caused by ice and snow build-up and removal of same.

The present invention, in one exemplary embodiment, includes a novel windshield weather protector device. The device includes one solid piece or sheet of thin flexible rubber with an attached flap. The thin flexible rubber sheet can be a generally rectangular sheet with a top edge to be placed near the top edge of the windshield. A bottom edge of the sheet can fit in the side edges of the windshield and a pair of handles disposed on opposing side edges enable a user to place/remove the device on/from the windshield. The flap can be attached to the thin flexible rubber sheet at a longitudinal or overlapping distance from about 4 inches to about 12 inches, thereby enabling the flap to cover a portion of the hood from about 4 inches to about 18 inches from the cowl area.

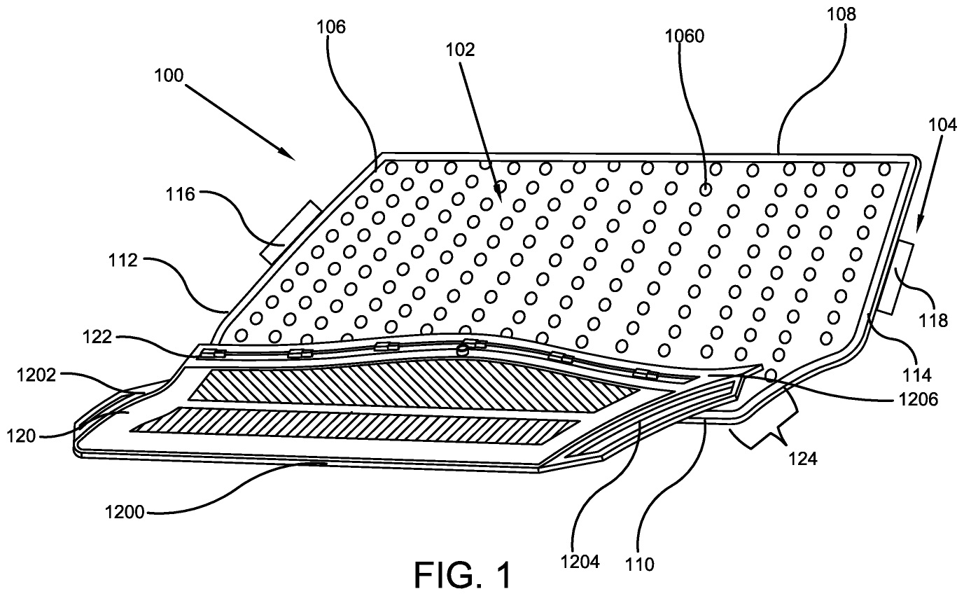

Referring initially to the drawings, FIG. 1 illustrates a perspective view of one potential embodiment of the automotive windshield and hood protecting cover of the present invention in accordance with the disclosed architecture. The windshield protecting cover 100 of the present invention includes a lightweight and durable weather protecting device for the windshield, windshield fluid spray nozzles, wipers and cowl, and provides protection from snow build-up and removal. The protecting cover 100 does not let snow and ice build-up and accumulate directly on the windshield, wiper arms and blades and cowl. More specifically, the protecting cover 100 includes a thin and pliable sheet of a weatherproof material that is adapted to cover the windshield, wiper arms and blades, cowl and a portion of hood. The cover 100 includes an exterior surface 102 that faces the inclement weather and receives snow, rain, sunshine and other weather elements. The interior surface 104 of the cover 100 faces an automobile to which the cover 100 is applied. The protecting cover 100 includes a generally rectangular windshield protecting portion 106, adapted to cover the windshield and the wiper arms and blades of the automobile. The windshield protecting portion 106 includes a top edge 108, a bottom edge 110, a first side edge 112 and a second side edge 114. The windshield protecting portion 106 includes a pair of handles 116, 118, with a first handle 116 disposed near the first side edge 112, and a second handle 118 disposed near the second side edge 114. The handles 116, 118 are used for placing the cover 100 precisely on the automobile, and removing same, and can also be used for hanging the cover 100 when not in use. The windshield protecting portion 106 is flexible, such that the bottom edge 110 fits into or over the cowl vent area of the vehicle and the planar surface of the windshield protecting portion 106 covers the windshield. The exterior surface 102 of the windshield protecting portion 106 includes projections 1060, that enable water and snow to slip down also prohibits accumulation of same.

A flap 120 can be attached to the windshield protection portion 106 using a permanent fastener 122, such as a permanent sewn edge. The flap 120 can be attached laterally above the bottom edge 110 of the windshield protecting portion 106, at a distance shown as overlapping area 124. Alternatively, the flap 120 may be integrally formed with the windshield protection portion 106. In one potential embodiment, the overlapping distance 124 can be from about 4 inches to about 12 inches. The portion of the windshield protecting area 106 that lies under the flap 120 is designed to work as an under flap or under layer, thereby enabling the bottom edge 110 to fit into the cowl vent area of the vehicle. The flap 120 can be made from flexible and weather-resistant material, and can be designed to cover a portion of hood of the vehicle. The flap 120 is generally rectangular in shape and includes a trailing edge 1200, a first side edge 1202 and a second side edge 1204, along with the top sewn edge 1206 that includes fasteners 122 for attaching the flap 120 to the windshield protecting portion 106 for forming a single unit cover 100 of the present invention. The flap 120 can be configured to create a protective layer from the bottom of the windshield to generally about 4 to 18 inches over the hood of the vehicle.

The windshield protecting portion 106 includes a thickness of between 0.2 inches and 2.0 inches based on the size of the cover 100. The flap 120 includes a thickness of between 0.2 inches and 2.0 inches. The windshield protecting portion 106 is large enough to cover a typical vehicle windshield and can be from about 50 inches to about 80 inches from side to side, between the first side edge 112 and the second side edge 114, and from about 30 inches to about 60 inches from the top edge 108 to the bottom edge 110. The flap 120 can be from about 60 inches to about 80 inches from side to side, and from about 8 inches to about 30 inches from sewn edge 1206 to the trailing edge 1200.

The cover 100 and all its components including the windshield protecting portion 106, flap 120, and handles 116, 118 can be made from a flexible, weather-resistant and resilient material including, but not limited to, a plastic material, a rubber material, a vinyl material, a flannel material, a canvas material or any other material. The material should be strong enough and durable enough so that the cover 100 can withstand a large accumulation of snow and ice thereon, and can be strong enough and sturdy enough so that it can withstand the removal of same using scrapers or other similar snow-removing tools. The cover 100 includes material able to withstand high temperatures, such as when the cover is used in hot weather, or in direct sunlight, as a sunscreen.

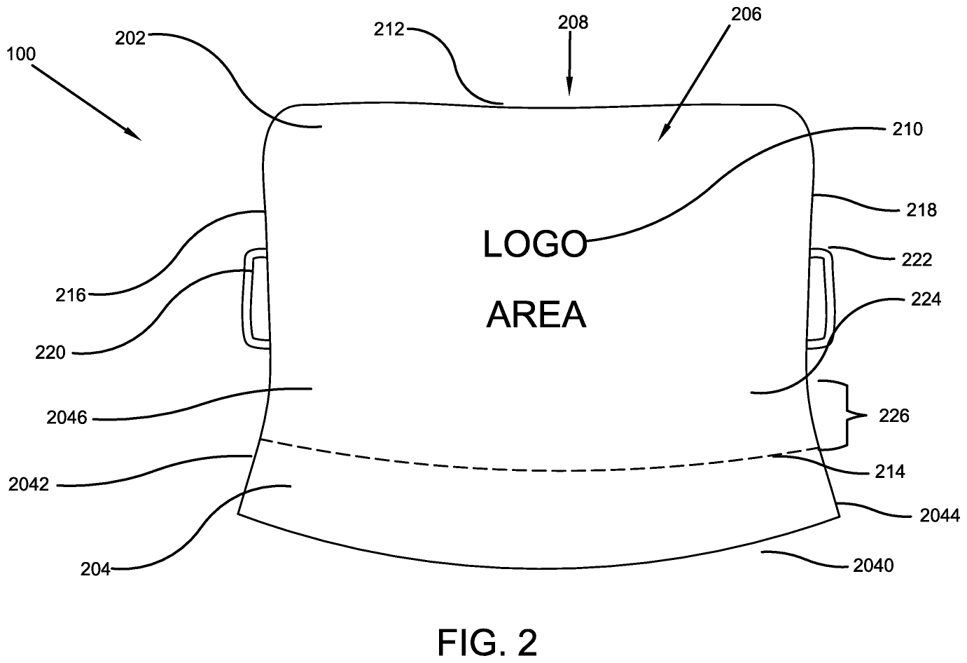

FIG. 2 illustrates a planar view of another embodiment of the windshield protecting cover of the present invention in accordance with the disclosed architecture. In the present embodiment, the windshield protecting cover 200 includes a planar windshield protecting sheet 202 and a hood portion protecting flap 204. The top surface 206 of the planar windshield protecting sheet 202 includes a logo 210 that can be any indicia, trademark, copyright or tag line for advertising and marketing purposes. The top surface 206 can be planar and void of outward projections. The rear surface 208 frictionally adheres to the windshield of the vehicle. The planar windshield protecting sheet 202 includes a top edge 212, a bottom edge 214, and a pair of side edges 216, 218. The edges 212, 214, 216, 218 help with enhanced grip and/or friction of the sheet 202 on the windshield and the sheet 202 also covers the wipers from snow as the bottom edge 214 fits into or over the cowl cavity of the vehicle. The flap 204 can be attached to the sheet 202 along the sewing or fastening edge 2046 of the flap 204 using a fastener 224 across the side-to-side length of the sheet 202. The portion 226 of the sheet between the bottom edge 214 and the lateral length of the sheet 202, where the flap 204 attached to the sheet 202 can be fixed into the cowl cavity of the vehicle, thereby protecting the cowl area from snow. The sewing edge 2046 can be positioned such that the flap 204 extends from the base of the windshield. The overlapping portion 226 lies underneath the flap 204 and is flexible, thus portion 226 can fit into or over the cowl area. Further, the flap 204 covers a portion of the hood of the vehicle and protects windshield fluid spray nozzles positioned on the hood of the vehicle from snow, ice, and inclement weather. The sewing or fastening edge 2046 can be positioned at the bottom of the windshield, and the flap 204 can extend from the fastening edge 2046 to the trailing edge 2040 to protect the hood with the side-to-side coverage of the flap 204 between the side edges 2042, 2044, thereby protecting the hood across its breadth.

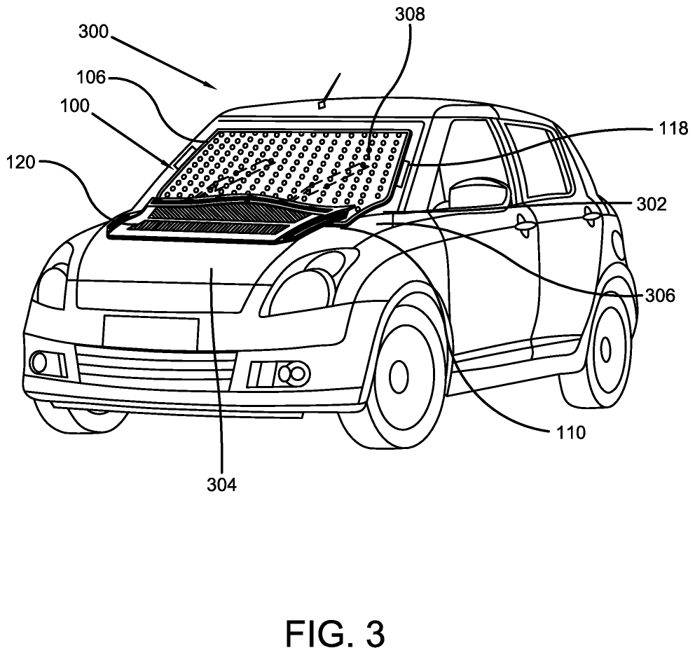

FIG. 3 illustrates a perspective view of the windshield and hood protection cover 100 of the present invention placed on a vehicle 300 for covering windshield and hood in accordance with the disclosed architecture. As stated, the application of the cover 100 of the present invention is for use on an automobile 300. As is well known in the art of automobiles 100, windshield wipers 308 are used for removing rain and snow from the windshield 302. Automobiles 100 are also well-known to have a hood 304 with the separation of the hood 304 to the windshield 302 via a cowl vent area 306. The windshield protection sheet 106 can be placed on the windshield 302 such that the bottom edge 110 of the sheet 106 fits into or over the cowl area 306, thereby enabling a portion of the sheet 106 to be used as an under flap for protecting the cowl area 306 from snow. The sheet 106 can be flexible and conformable to the shape of the windshield surface 302 in a non-sticky manner. The sheet 106 also protects the wipers 308 from snow and ice, and thus protects the wiper arms and blades as well.

Flexibly and permanently attached to the sheet 106, the flap 120 covers a portion of the hood 304, preferably including the windshield nozzles disposed on the hood 304. The flap 120 provides additional protection for the cowl area 306 as the flap 120 overlaps the portion of the sheet 106 that fits into the cowl area 306.

The handle 118 disposed on the sheet 106 can be accessed by a driver even while sitting in the vehicle 300 for removing the cover 100 when not needed or to quickly clear ice and snow from the windshield 302 so that the vehicle 300 can be driven after an episode of winter weather.

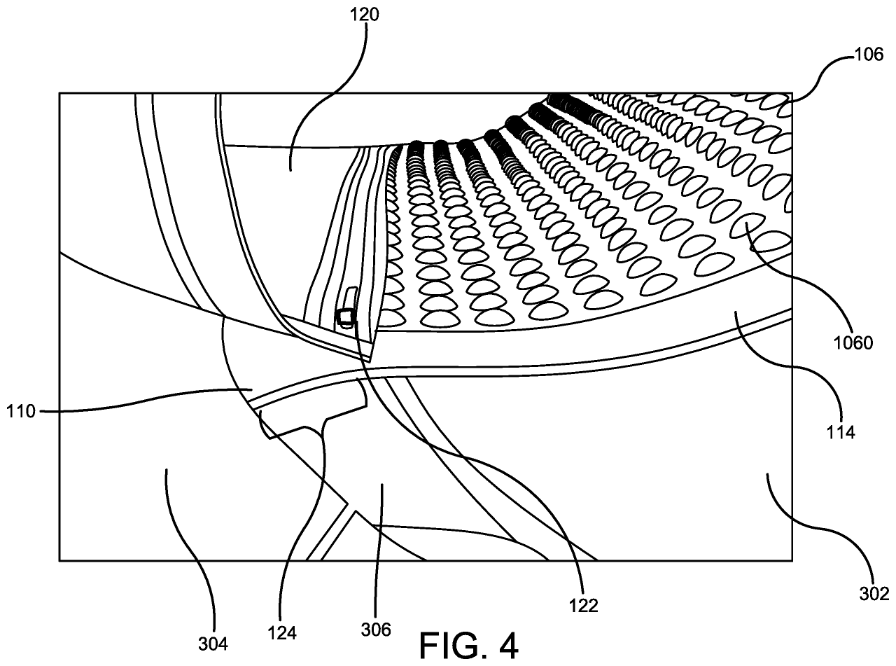

FIG. 4 illustrates an enlarged view showing how the portion 124 of the sheet 106 is placed underneath the flap 120 for covering the cowl area 306 in accordance with the disclosed architecture. The advantage of the cover 100 of the present invention that it protects the windshield 302, cowl area 306, a portion of the hood 304, and wipers (308 as shown in FIG. 3). As shown, the portion 124 of the windshield sheet 106 extending from the point of attachment of the flap 120 and the sheet 106 using the fastener 122 and extending to the bottom edge 110 of the sheet 106 can be placed underneath the flap 120. The overlapping portion 124 can be flexible enough to fit into the cowl area 306 to provide continuous protection between the windshield and the hood in a sloping manner.

It should be noted that the cover 100, including the windshield sheet 106 and the flap 120, can be a single and unitary unit with no necessary assembly required during use of the cover 100. The projections 1060 on the windshield sheet 106 enable a smooth removal of the snow when the vehicle is to be used by a user.

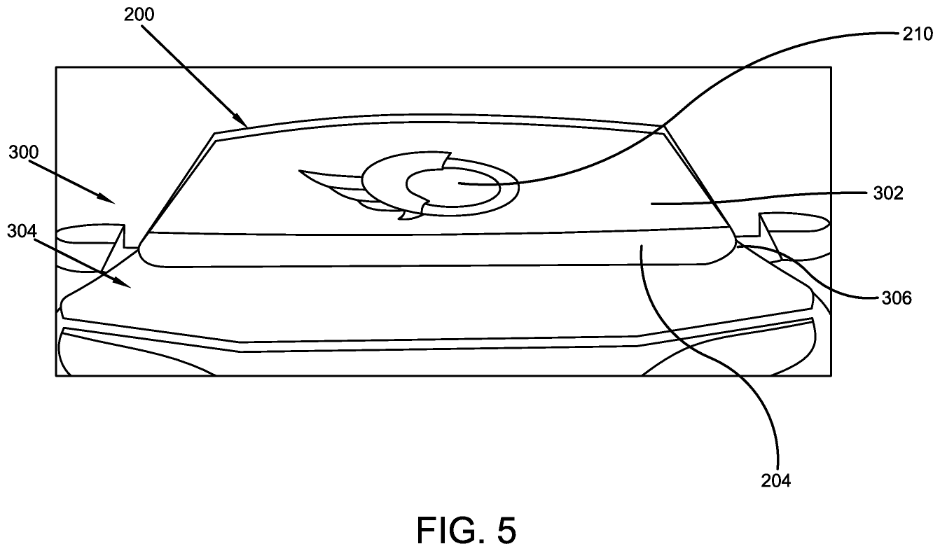

FIG. 5 illustrates a perspective view showing the windshield protecting cover 200 covering the windshield and hood of the vehicle 300 in accordance with the disclosed architecture. When the windshield protecting cover 200 is placed on the vehicle 300, the logo 210 is visually exposed to the outside and provides an aesthetic appeal to the vehicle 300. The cover 200 can be wide enough and long enough to protect and cover the windshield 302, the cowl area 306, and a portion of the hood 304 using the flap 204.

It should be noted that the cover 200 and its integral components are flexible and include the contoured shape to precisely and properly cover the windshield 302, the cowl area 306, and a portion of the hood 304.

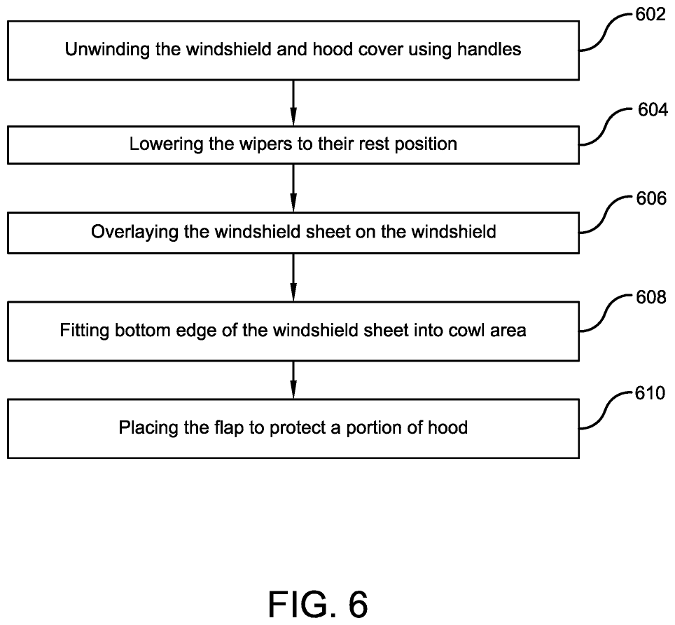

FIG. 6 illustrates a flow diagram showing exemplary steps performed by a user for using the windshield and hood protection cover 100 of the present invention on a vehicle in accordance with the disclosed architecture. It should be understood that the present embodiment states the basic flow performed by a user and additional actions may be used to add additional installation processes to the basic flow. Initially, the windshield and hood cover is unwound or opened using handles provided on the cover (Block 602). Then, optionally, the wipers of the vehicle on which the cover is to be used are lowered to their resting position (Block 604). Thereafter, the windshield sheet is overlaid on the windshield such that a majority of the windshield is covered by the sheet from side to side and top to bottom (Block 606). For protecting the cowl area, the bottom edge of the windshield sheet is fitted into or over the cowl area with a portion of the sheet (Block 608). Finally, the flap is placed overlapping the cowl area and extending therefrom to cover a portion of the hood (Block 610).

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “windshield and hood protection cover”, “windshield protection cover”, “protection cover”, “cover”, “automobile windshield cover”, and “automotive windshield cover” are interchangeable and refer to the windshield and hood protection cover 100, 200 of the present invention.

Notwithstanding the forgoing, the windshield and hood protection cover 100, 200 of the present invention can be of any suitable size and configuration as is known in the art without affecting the overall concept of the invention, provided that it accomplishes the above-stated objectives. One of ordinary skill in the art will appreciate that the size, configuration, and material of the windshield and hood protection cover 100, 200, as shown in the FIGS., are for illustrative purposes only, and that many other sizes and shapes of the windshield and hood protection cover 100, 200 are well within the scope of the present disclosure. Although the dimensions of the windshield and hood protection cover 100, 200 are important design parameters for user convenience, the windshield and hood protection cover 100, 200 may be of any size that ensures optimal performance during use, and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A weather protecting cover for a windshield, wiper arms and blades, cowl grill and a hood portion of a vehicle, the weather protecting cover comprising:
a pliable cover of weatherproof material including a first sheet portion configured to cover the windshield, wiper arms and blades, and cowl grill of the vehicle, and a second flap portion configured to overlap said first sheet portion and extend over the hood portion of the vehicle;
said cover includes an exterior surface that receives weather elements thereon, and an interior surface facing an automobile to which said cover is applied;
said first sheet portion includes a generally rectangular configuration having a top edge, a bottom edge, a first side edge, and a second side edge, wherein at least one of said first side edge and said second side edge include a handle for grasping said cover; and
said exterior surface of said cover includes projections extending therefrom for shedding accumulation of water, ice, and snow thereon.

2. The weather protecting cover of claim 1, wherein said second flap portion fastenable to said first sheet portion.

3. The weather protecting cover of claim 2, wherein said second flap portion permanently fastened to said first sheet portion.

4. The weather protecting cover of claim 2, wherein said second flap portion fastened laterally above a bottom edge of said first sheet portion to form an overlapping area.

5. The weather protecting cover of claim 4, wherein said overlapping area includes an extension distance from about 4 inches to about 12 inches.

6. The weather protecting cover of claim 4, wherein said overlapping area of said first sheet portion arranged to fit into the cowl grill area.

7. The weather protecting cover of claim 4, wherein said overlapping area of said first sheet portion arranged to fit over the cowl grill area.

8. The weather protecting cover of claim 5, wherein said second flap portion includes an area having a first extension distance from about 4 inches to about 18 inches from the cowl grill.

9. The weather protecting cover of claim 8, wherein said first sheet portion includes a thickness from about 0.2 inches to about 2.0 inches.

10. The weather protecting cover of claim 9, wherein said second flap portion includes a thickness from about 0.2 inches to about 2.0 inches.

11. The weather protecting cover of claim 10, wherein said first sheet portion includes a first flexible material selected from the group consisting of a plastic material, a rubber material, a vinyl material, a flannel material, and a canvas material.

12. The weather protecting cover of claim 11, wherein said second flap portion includes a second flexible material selected from the group consisting of a plastic material, a rubber material, a vinyl material, a flannel material, and a canvas material.

13. The weather protecting cover of claim 12, wherein said first flexible material is different than said second flexible material.

14. The weather protecting cover of claim 13, wherein said first sheet portion frictionally retained to the windshield.

15. A weather protecting cover for a windshield, wiper arms and blades, cowl grill and a hood portion of a vehicle, the weather protecting cover comprising:
a pliable cover of weatherproof material including a first sheet portion constructed to cover the windshield, wiper arms and blades, and cowl grill of the vehicle, and a second flap portion constructed to overlap said first sheet portion and extend over a portion of the vehicle hood;
said extension over a portion of the vehicle hood includes at least a windshield fluid spray nozzle positioned on the vehicle hood;
said cover includes an exterior surface that receives weather elements thereon, and an interior surface facing an automobile to which said cover is applied;
said first sheet portion includes a generally rectangular configuration having a top edge, a bottom edge, a first side edge, and a second side edge, wherein at least one of said first side edge and said second side edge include a handle for grasping said cover; and
said first sheet portion frictionally retained to the windshield.

16. The weather protecting cover of claim 15, wherein said second flap portion fastenable laterally above a bottom edge of said first sheet portion to form an overlapping area.

17. The weather protecting cover of claim 16, wherein said overlapping area of said first sheet portion arranged to fit into the cowl grill area.

18. The weather protecting cover of claim 17, wherein said exterior surface of said cover includes projections extending therefrom for shedding accumulation of water, ice, and snow thereon.

19. A weather protecting cover for a windshield, wiper arms and blades, cowl grill, and a hood portion of a vehicle, the weather protecting cover comprising:
a pliable cover of weatherproof material including a first sheet portion constructed to cover the windshield, wiper arms and blades, and cowl grill of the vehicle, and a second flap portion constructed to overlap said first sheet portion and extend over a portion of the vehicle hood;
said extension over a portion of the vehicle hood includes at least a windshield fluid spray nozzle positioned on the vehicle hood;
said cover includes an exterior surface that receives weather elements thereon, and an interior surface facing an automobile to which said cover is applied;
said first sheet portion includes a generally rectangular configuration having a top edge, a bottom edge, a first side edge, and a second side edge, wherein at least one of said first side edge and said second side edge include a handle for grasping said cover;
said first sheet portion frictionally retained to the windshield;
said first sheet portion includes a first flexible material selected from the group consisting of a plastic material, a rubber material, a vinyl material, a flannel material, and a canvas material;
said second flap portion includes a second flexible material selected from the group consisting of a plastic material, a rubber material, a vinyl material, a flannel material, and a canvas material; and
said first flexible material is different than said second flexible material.

20. The weather protecting cover of claim 19, wherein said second flap portion is fastenable laterally above a bottom edge of said first sheet portion to form an overlapping area, and further wherein said overlapping area of said first sheet portion arranged to fit into the cowl grill area.
